(19) United States
(12) Patent Application Publication
(10) Pub. No.: US 2026/0158653 A1
(43) Pub. Date: Jun. 11, 2026

(54) DETERMINING A CONFIGURATION OF AN ARTICULATED STRUCTURE

(71) Applicant: Orange, Issy-les-Moulineaux (FR)

(72) Inventors: Olivier HOTEL, CHATILLON CEDEX (FR); Franck ROUDET, CHATILLON CEDEX (FR)

(21) Appl. No.: 19/416,991

(22) Filed: Dec. 11, 2025

(30) Foreign Application Priority Data
Dec. 11, 2024 (FR) FR2413873

(51) Int. Cl. B25J 9/16

(52) U.S. Cl. CPC B25J 9/1664; B25J 9/1612

(57) ABSTRACT

A method implemented by a computer, the method including: determining a configuration of an articulated structure by taking into account positions of keypoints of the articulated structure, and at least one topological relationship between keypoints.

### CROSS-REFERENCE TO RELATED APPLICATIONS

This application claims foreign priority to FR2413873, filed Dec. 11, 2024, the contents of which are incorporated by reference herein in its entirety.

### BACKGROUND

### Field

This disclosure falls within the domain of analyzing and interpreting data concerning articulated structures. More specifically, it relates to a method for determining the configuration of an articulated structure, and a corresponding system, computer program, and storage medium.

### Description of the Related Technology

Existing systems for recognizing dynamic patterns or gestures generally rely on approaches based on image or video data. Some approaches use artificial intelligence algorithms such as convolutional neural networks (CNNs), recurrent neural networks (RNNs), or transformers. These neural networks are trained to detect static gestures in images or dynamic gestures in ordered sequences of images. While effective under certain conditions, these approaches often suffer from high computational costs and require significant hardware resources, limiting their adoption in resource-constrained environments.

Other approaches make use of keypoints extracted from the articulated structure to represent patterns. These keypoints are used as vectors or tensors and are processed by models such as multilayer perceptrons (MLPs). However, these methods do not always accurately recognize complex patterns or dynamic movements.

In this context, there is a need for a technique that overcomes these limitations, offering accurate and robust recognition of configurations and dynamic movements, while optimizing the hardware resources required.

### SUMMARY

This disclosure improves the situation.

According to one aspect, a method implemented by computer is proposed, which comprises:
determining a configuration of an articulated structure by taking into account:
   positions of keypoints of the articulated structure, and
   at least one topological relationship between keypoints.

According to another aspect, a system is proposed comprising:
a module for determining a configuration of an articulated structure by taking into account:
   the positions of keypoints of the articulated structure, and
   at least one topological relationship between keypoints.

According to another aspect, a computer program is proposed comprising instructions which, when the program is implemented by a processor, lead to implementing the method as defined herein. According to another aspect, a non-transitory, computer-readable storage medium is proposed on which such a program is stored.

The described system, computer program, and storage medium are capable of implementing all embodiments of the described method.

The proposed technique offers numerous advantages. For example, in at least in some embodiments, it can contribute to:
improving accuracy in recognizing complex configurations by taking into account the topological neighborhood of keypoints (i.e., local spatial relationships between adjacent keypoints),
increasing the efficiency of computational resources, making the proposed technique suitable for constrained or real-time environments,
extensibility for dynamic applications, as the proposed technique can be repeated over time to identify dynamic movements of the articulated structure, and
compatibility with various data capture devices, such as 2D or 3D cameras or motion capture systems, facilitating widespread integration into a variety of existing systems.

The features described in the following paragraphs may optionally be implemented, independently or in combination.

In at least one embodiment, the positions of the keypoints are expressed in a first coordinate system and the at least one topological relationship is expressed in a second coordinate system.

In at least one embodiment, the first coordinate system is a Cartesian coordinate system and the second coordinate system is a polar, cylindrical, or spherical coordinate system.

In at least one embodiment, the articulated structure comprises a hand and a wrist.

In at least one embodiment, the articulated structure is divided into a plurality of articulated substructures, each substructure comprising at least one joint and/or at least one end.

In at least one embodiment, a topological relationship comprises a distance and/or an angle.

In at least one embodiment, a topological relationship is at least one element of a list comprising:
a proximity relationship between keypoints,
a relationship between keypoints belonging to a same articulated substructure, or
a relationship between keypoints belonging to different articulated substructures.

In at least one embodiment, the determined configuration of the articulated structure is chosen from a discrete set of possible configurations.

In at least one embodiment, the determination of the configuration is repeated over time, the method comprising:
determining a dynamic movement of the articulated structure based on the determined configurations.

In at least one embodiment, the determination of the dynamic movement of the articulated structure comprises:
constructing a sequence of symbols, a symbol representing a determined configuration, and
detecting a pattern in the sequence of symbols.

In at least one embodiment, the configuration of the articulated structure is determined using a convolutional neural network applied to the data obtained.

In at least one embodiment, the data are structured in a form that allows deducing at least one topological relationship.

In at least one embodiment, the method comprises a determination of a user command based on a similarity between the determined configuration and a configuration associated with said command.

### BRIEF DESCRIPTION OF DRAWINGS

Other features, details and advantages will become apparent from the detailed description below and from an analysis of the accompanying drawings, cited as simple, non-limiting examples, in which:

FIG. 1 shows, in one exemplary implementation, a method for determining the configuration of an articulated structure.

FIG. 2 shows, in one exemplary implementation, a static configuration of an articulated structure.

FIG. 3 shows, in one exemplary implementation, a result of a change of coordinate system applied to the keypoints of an articulated structure.

FIG. 4 shows, in one exemplary implementation, a tensor organizing keypoint data.

FIG. 5 shows, in one exemplary implementation, a method for determining a configuration of an articulated structure.

FIG. 6 shows, in one exemplary implementation, a dynamic configuration of an articulated structure.

### DETAILED DESCRIPTION OF CERTAIN ILLUSTRATIVE EMBODIMENTS

In the drawings, identical reference numbers designate identical elements or elements having similar functions.

We now clarify a few specific terms, to provide a better understanding of the proposed technique.

An articulated structure is an entity composed of segments connected by joints that allow relative movement between the segments. For example, a human hand is an articulated structure comprising several substructures, such as the fingers (each finger is a substructure) and the wrist (a common reference point for the whole, for example). An articulated substructure is an identifiable part of an articulated structure, comprising at least one joint (e.g., finger joint) and/or one end (e.g., fingertip).

A static configuration of an articulated structure is a specific arrangement or pose of the segments of the articulated structure, at a given moment. This configuration is defined by the relative positions of the keypoints of the articulated structure, expressed in terms of spatial relationships (e.g., distances, angles, and/or alignments) between these keypoints. For a human hand, a static configuration might correspond, for example, to an open hand, a closed fist, or a pointing finger. In the case of a pointing finger, the joints of the pointing finger are aligned, while those of the other fingers are folded towards the palm. For a robotic structure, a static configuration might correspond to a resting position or a posture adopted to perform a specific task (e.g., a robotic arm extended forward). A static configuration is unmoving and does not change over time. It constitutes a snapshot of the articulated structure at a precise moment, without taking into account any movements that may precede or follow it.

A dynamic configuration of an articulated structure is a sequence of successive static configurations that may evolve over time and form a movement or gesture (a prolonged lack of motion in the same static configuration can be considered a gesture in some embodiments). A dynamic configuration is characterized by the variation over time of the positions of keypoints and of the spatial relationships between them. For a human hand, a dynamic configuration might correspond to a closing movement of the hand (from an open position to a closed fist). Another dynamic configuration might be a gesture of approval (raising the thumb from a closed hand). For a robotic structure, a dynamic configuration might correspond to the movement of a robotic arm from a pickup point to a releasing position. In a dynamic configuration, the topological relationships between keypoints, such as distances and angles, evolve continuously or in discrete steps. Dynamic configurations can be analyzed to identify specific patterns, such as gestures, paths, or complex movements.

Determining a configuration of an articulated structure means identifying, analyzing, and/or recognizing a particular arrangement of the segments and joints of the articulated structure based on the data obtained. This process may include classification, for example assigning the detected configuration to a predefined category. For a hand, determining a configuration may mean recognizing that it is open or closed by analyzing the relative positions of the joints and fingertips.

Keypoints are specific locations defined on an articulated structure to represent segments, joints, fingertips, or other features of the articulated structure. For a hand and wrist, keypoints may include, for example, the center of the wrist, the proximal, intermediate, and distal joints of the fingers, or the fingertips.

A position of a keypoint may be defined in a two-dimensional or three-dimensional space, with various coordinate systems. For example, in a three-dimensional space, the position data of keypoints may be expressed as Cartesian coordinates (x, y, z), cylindrical coordinates (r, θ, z), and/or spherical coordinates (r, θ, q). For example, in a two-dimensional space, the position data of keypoints may be expressed as Cartesian coordinates (x, y) and/or polar coordinates (r, θ).

A reference point is a point defined in two-dimensional or three-dimensional space, used as a basis for expressing spatial or functional relationships between keypoints of an articulated structure. The reference point may, for example, be chosen so as to be stable and representative of the structure as a whole or of a specific substructure. For example, for a hand, the center of the wrist may serve as a common reference point for all keypoints, as it remains relatively immobile in relation to the finger movements. In a robotic arm, a reference point may be placed at the base of the main joint to express the positions and orientations of the segments.

A reference direction is a direction used as a basis for expressing spatial angular relationships. It may be chosen to correspond to a geometric or functional feature of the articulated structure. For example:
the longitudinal axis of the articulated structure, such as the axis of the arm for a hand, or
a direction orthogonal or parallel to a segment defined by two keypoints (for example, between a proximal joint and an intermediate joint), or
an absolute direction in a general coordinate system (for example, the x, y or z axis of a three-dimensional Cartesian coordinate system).

A relative distance between two keypoints, or between a keypoint and a reference point, can be expressed in several ways. The Euclidean distance r₁₂ between a first point with Cartesian coordinates (x₁, y₁, z₁) and a second point with Cartesian coordinates (x₂, y₂, z₂) in a three-dimensional space can be expressed as a scalar value, calculated according to the relation r₁₂=\sqrt{(x₂−x₁)²+(y₂−y₁)²+ (z₂−z₁)²}. The relative distance between two keypoints, or between a keypoint and a reference point, may be normalized, i.e., expressed as a proportion of a reference length (for example, the total length of an articulated structure or a portion of the articulated structure).

The orientation of a keypoint may be expressed as an angular deviation between the vector connecting a keypoint to the reference point, and the reference direction. For example, in a polar or cylindrical coordinate system, the orientation of a keypoint may be expressed as an angle between the keypoint, the reference point, and an axis chosen as the reference direction. For example, in a spherical coordinate system, the orientation of a keypoint may be expressed as a solid angle formed by a vector defined by a line segment (e.g., wrist to tip of the middle finger) in relation to a general or local direction.

The reference point may be placed at the origin of a coordinate system, in particular a polar, cylindrical, or spherical coordinate system. In this case, the relative distance between a keypoint and the reference point corresponds to the radius r, expressing the Euclidean distance between these two points. The relative orientation of the keypoint is expressed, in a polar or cylindrical coordinate system, by the angle between the vector connecting the keypoint to the reference point, and a reference direction defined starting from the reference point. The orientation of a keypoint is expressed, in a spherical coordinate system, as a first angle between the projection of the vector connecting the keypoint to the reference point onto a first plane and a first main axis chosen as the reference direction in this first plane, and a second angle between the projection of the vector connecting the keypoint to the reference point onto a second plane orthogonal to the first plane and a second main axis orthogonal to the first main axis and chosen as the reference direction in this first plane.

In the case of a human hand, if the reference point is the center of the wrist, and if a first reference direction is the longitudinal axis of the forearm (z axis, oriented from the elbow to the wrist) and a second reference direction is the axis transverse to the plane defined by the forearm and hand in a neutral position (x axis, oriented perpendicularly to the z axis and aligned with the width of the hand at the center of the wrist), the spherical coordinates of a keypoint, such as a fingertip, allow us to capture:
the distance r, which describes the distance to the fingertip from the center of the wrist;
the angle θ, which describes the horizontal orientation of the fingertip relative to the center of the wrist and the x axis; and
the angle q, which describes the vertical inclination of the fingertip relative to the center of the wrist and the z axis.

The topology of an articulated structure refers to the logical and spatial organization of keypoints within that articulated structure, as well as the relationships between them. It does not necessarily refer to a strict mathematical definition of topology, but rather serves to describe the order in which keypoints are connected or arranged (for example, the sequence of joints of a finger) and/or the spatial relationships between keypoints, for example in the form of distances, angles, and/or alignments. In a human hand, topology captures the organization of the fingers and joints, defining the logical connections between the wrist, the finger joints and fingertips, as well as the relative arrangement of the fingers with respect to one another.

A topological relationship refers to information describing a functional interaction or a spatial relationship between at least two keypoints of an articulated structure. A topological relationship may be a proximity relationship between keypoints, for example an adjacency relationship, meaning a direct relationship between two keypoints connected by a segment or a joint, for example the relative arrangement of a proximal and intermediate joint of a finger. A topological relationship may be a relationship internal to a substructure, meaning a relationship between keypoints that are part of a same substructure, for example a finger, or the relative arrangement of a distal joint and fingertip. A topological relationship may also be a relationship between different substructures, meaning a relationship between keypoints that are part of different substructures, for example the relative arrangement of the fingertips in a hand.

In a static context, a topological relationship between two keypoints, or between a keypoint and a reference point, may be expressed as one or more of the following:
a distance, i.e., a spatial proximity;
an angle, i.e., an orientation relative to a reference direction; and
a hierarchical relationship, such as a functional or structural dependency, for example a direct connection or adjacency.

Topological relationships may extend to sets of three or more keypoints, making it possible to capture complex spatial and functional features. A topological relationship might, for example, include a local curvature or a relative symmetry. Local curvature is a measure of the deviation between successive keypoints in an articulated substructure. For example, in a finger, the curvature may be expressed as the angle formed by the segments connecting three joints (proximal, intermediate, and distal). High curvature indicates a bent finger, while low curvature characterizes an extended finger. Relative symmetry describes correspondences between different substructures in an articulated structure. For example, in an open hand, the index and ring fingers may exhibit an approximate symmetry in their position and orientation. This symmetry may be expressed as geometric relationships, such as similar distances or angles relative to a central axis (e.g., the axis of the middle finger).

In a dynamic context, topological relationships are not fixed and may vary over time to reflect movements (or a lack of movement) of the articulated structure. Each keypoint may have a defined path in space, represented by a sequence of successive positions. Thus, the topological relationship between a fingertip and the wrist may, for example, be described by a series of distances and/or angles that change over time.

The topological neighborhood of a keypoint refers to the set of topological relationships that define its interaction with other nearby keypoints in the articulated structure. These relationships may be direct or indirect. For example, in a hand, the topological neighborhood of the middle finger's intermediate joint may include, but is not limited to:
adjacency relationships with the proximal and distal joints of the middle finger (therefore with keypoints of the same substructure),
a spatial proximity relationship with the middle joint of the ring finger (therefore with keypoints of a different substructure).

The terms “topology,” “topological relationship,” and “topological neighborhood” are used in this document as abstractions to describe spatial relationships, without necessarily implying a strict geometric or mathematical structure. These concepts allow characterizing the static and/or dynamic configurations of a joint structure, according to the desired application.

This disclosure relates to a technique for determining a configuration of an articulated structure.

In the field of detecting hand gestures, the existing systems can be divided into two main categories.

A first category of systems relies on image analysis algorithms. For static gesture detection, a convolutional neural network (CNN) is often used to extract visual features (such as edges, textures, or shapes) directly from provided images. A recurrent neural network (RNN) may be used in conjunction with the convolutional neural network (CNN) to process a video sequence and thus detect dynamic gestures. Such systems require significant computing power, are sensitive to variations in lighting and background, and are highly dependent on the quality of the images provided.

A second category of systems relies on classification algorithms. Multilayer perceptrons (MLPs) are often used to process keypoints representing joints of the hand or fingertips and to recognize static configurations. Long short-term memory (LSTM) recurrent neural networks are also used to analyze temporal sequences of keypoints and recognize dynamic patterns. These approaches often lack accuracy for complex configurations or subtle movements.

Unlike existing gesture detection systems based on an image or video of a hand, the proposed technique relies on the use of data representing the positions of keypoints and their topological relationships, rather than on a pixel-by-pixel analysis of an image. The proposed technique is therefore independent of variations in lighting, background, or image quality, and is less computationally intensive, making it suitable, at least in some embodiments, for embedded systems or those with real-time constraints.

Unlike existing gesture detection systems based on keypoints of a hand, the proposed technique explicitly takes into account topological relationships between keypoints, which improves the accuracy and reliability in recognizing complex configurations. Optionally, the proposed technique uses a convolutional neural network to exploit topological relationships and further improve configuration classification.

The proposed technique thus differs from the state of the art, in particular from existing gesture detection systems.

The proposed technique is not limited to the hand, but applies to any articulated structure, such as arms, legs, or parts of the human skeleton, articulated robotic structures, or even animal structures (tails, paws, etc.). Due to this, the method is independent of the specific nature of the articulated structure, which enables it to be used in various fields (biomechanics, robotics, sports, etc.). The proposed technique may be applied, for example, in order to determine a configuration of an entire human body; the configuration thus determined can then be used to determine a person's activity.

Some concepts specific to artificial neural networks are now presented.

Artificial neural networks (ANNs) are computational models inspired by the biological structure of the brain. They are composed of layers of interconnected neurons that transform inputs into outputs through adjustable weights and activation functions. A network comprises input layers, hidden layers, and output layers. Each layer comprises neurons configured to perform linear or nonlinear transformations on the data provided to them. The weights of the connections between neurons are adjusted during a training phase, using algorithms such as backpropagation, which minimizes a cost function. Training may be supervised or unsupervised. The output of a neural network is typically a probability vector or numerical scores associated with predefined classes. In the context of the present document, the classes are possible configurations of an articulated structure.

Among the different types of artificial neural networks, there exist in particular:
convolutional neural networks (CNNs),
recurrent neural networks (RNNs),
long short-term memory recurrent neural networks (LSTMs), and
multilayer perceptrons (MLPs).

CNNs are designed to process data organized into grids. CNNs apply convolutional filters that slide across the input grid to extract relevant local features. These filters allow detecting specific patterns, such as textures, edges, or spatial structures, by analyzing local relationships in the data. With each convolutional layer, the extracted features become increasingly abstract, progressing from basic patterns (e.g., edges) to complex concepts (e.g., parts of an articulated structure).

In a typical use of a CNN, images captured by a camera are converted into matrices of pixels. For example, a grayscale image is represented by a 2D grid, where each cell contains a light intensity value (e.g., 0 for black, 255 for white). A color image is encoded into a 3D grid, with three channels (red, green, blue), each channel containing a grid of intensities for the corresponding color. The CNN analyzes this grid or these grids to extract patterns useful to the task, such as recognizing a static hand gesture. Before being processed by the CNN, the images may be normalized, resized, or encoded.

In one use of a CNN according to an embodiment of the proposed technique, keypoint data are provided as input in the form of structured tensors. A tensor is a multidimensional structure (e.g., 2D, 3D, or higher) organized to reflect the features of the input data. For an articulated structure, each keypoint can be represented by a set of values (for example its coordinates in one or more systems). For example, a set of values representing a keypoint might be a triplet, comprising the position (x, y) of the keypoint in a Cartesian coordinate system and the distance (r) between the keypoint and the origin of the coordinates in a polar coordinate system. Alternatively, a set of values representing a keypoint might be a quadruplet which also includes the polar angle (θ). These sets of values can be organized in a tensor to reflect the topological relationships between keypoints (e.g., adjacent points located in nearby boxes). In addition to the positions of keypoints, the tensor may include explicit topological relationships, such as distances and angles. Alternatively, the tensor structure itself may be chosen so that the CNN implicitly infers these relationships from the data arrangement. This embodiment of the proposed technique allows the CNN to directly analyze the data of the articulated structure, which reduces the complexity in comparison to the known use of a CNN for image analysis.

RNNs are designed to process data sequences, by means of recurrent connections that allow maintaining a memory of previous states. At each time step, the RNN takes data from the sequence as input (e.g., a static configuration detected by a CNN) and updates its internal state. This internal state captures the history of previous data, enabling the RNN to model temporal relationships. Simple RNNs may struggle to capture temporal relationships over long sequences due to gradient vanishing during training. In a system which combines CNNs and RNNs to detect dynamic gestures, the CNN determines successive static configurations from input images, and the RNN analyzes these configurations over time to detect patterns or dynamic gestures.

MLPs are fully connected networks where each neuron in each layer is connected to all the neurons in the preceding layer. MLPs are well-suited for processing feature vectors, where each feature is an input. The data is transformed across multiple layers, with each transformation enabling the detection of increasingly complex patterns. MLPs can classify static configurations of the articulated structure (e.g., “open hand,” “closed fist”) based on the positions of keypoints. They are often used for tasks where temporal relationships are not required.

LSTMs are a variant of RNNs, designed to process long sequences while overcoming vanishing gradient problems. LSTMs use memory cells and gating mechanisms (in, forget, out) to control which information is stored, updated, or forgotten at each time step. This allows them to capture complex temporal relationships over long sequences. LSTMs can analyze sequences of static configurations to detect complex dynamic gestures, such as a greeting or a fluid hand-closing movement. They are particularly useful for modeling subtle gestures that require considering long-term temporal relationships.

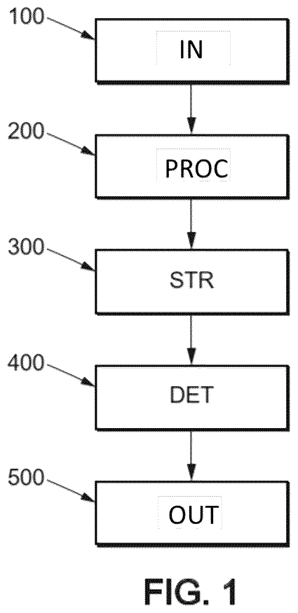

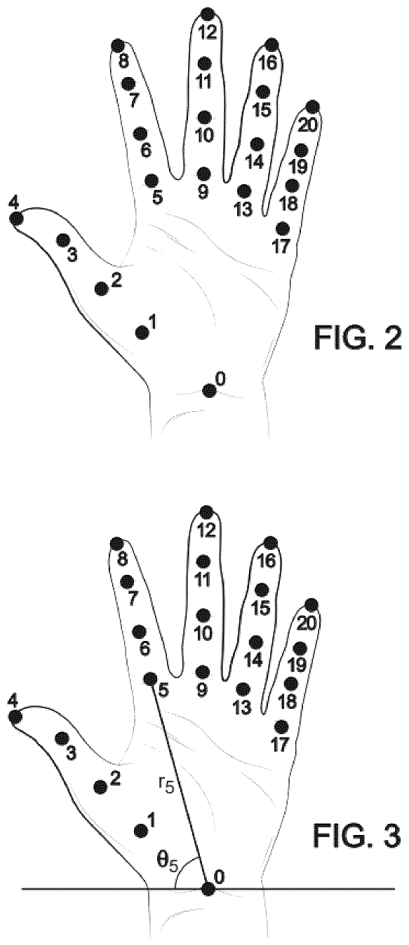

Reference is now made to FIGS. 1 and 2.

FIG. 1 shows one possible example of a flowchart of a method suitable for implementing the proposed technique. This flowchart shows different logic modules, each defined by a specific function:
an input module 100,
a processing module 200,
a structuring module 300,
a configuration determination module 400, and
an output module 500.

FIG. 2 shows a human hand as one possible example of an articulated structure, for which twenty-one keypoints are defined as follows.

Keypoint 0 is located in the center of the wrist. Four keypoints, 1, 2, 3, and 4, are located at the proximal, middle, and distal joints and at the tip of the thumb. Four keypoints, 5, 6, 7, and 8, are respectively located at the proximal, middle, and distal joints and at the tip of the index finger. Four keypoints, 9, 10, 11, and 12, are respectively located at the proximal, middle, and distal joints and at the tip of the middle finger. Four keypoints, 13, 14, 15, and 16, are respectively located at the proximal, middle, and distal joints and at the tip of the ring finger. Four keypoints, 17, 18, 19, and 20, are respectively located at the proximal, middle, and distal joints and at the tip of the little finger.

The input module 100 is configured to obtain the positions of the keypoints of the structure in a coordinate system, for example in the form of pairs (xᵢ, yᵢ) where xᵢ and yᵢ are the horizontal and vertical positions of a keypoint i in an image formed by a grid of pixels. The pairs are concatenated to form, in the example in FIG. 2, a 42-dimensional vector (21 keypoints and 2 values per keypoint). The keypoint positions can be obtained using various methods which are known per se.

The processing module 200 and the structuring module 300 are respectively configured to process and organize the keypoint positions obtained by the input module in order to prepare them for further processing by the configuration determination module 300.

The processing by the processing module 200 may comprise one or more operations to transform and/or enrich the obtained positions.

For example, the processing may comprise a change of coordinates. The positions of keypoints may be expressed in a new coordinate system, for example by placing a specific point (such as keypoint 0, the center of the wrist) at the origin. The position of keypoint i in this coordinate system can be calculated, in Cartesian coordinates, as (xᵢ−x₀, yᵢ−y₀), where x₀ and y₀ are the horizontal and vertical positions of keypoint 0 as obtained from the input module 100, and xᵢ, yᵢ are the horizontal and vertical positions of keypoint i.

For example, the processing may involve a change of coordinate system. The position of keypoint i, expressed in Cartesian coordinates in a system having keypoint 0 as its origin, may for example be converted into polar coordinates (rᵢ, θᵢ) where:

$${r}_{i} = \sqrt{{( {x}_{i} - {x}_{0} )}^{2} + {( {y}_{i} - {y}_{0} )}^{2}}$$

$$and$$

$${θ}_{i} = arctan ( {y}_{i} - {y}_{0} , {x}_{i} - {x}_{0} ) .$$

FIG. 3 illustrates the result of such a change of coordinate system for keypoint 5. The conversion to polar coordinates is particularly useful here, allowing module 300 to directly analyze distances and/or angles between keypoints and the center of the wrist.

For example, the processing could comprise enhancing the obtained given positions by adding topological relationships derived from or calculated from obtained positions. The distance rᵢ and the angle θ; are examples of topological relationships derived from the obtained positions x₀, xᵢ, y₀ and yᵢ.

Other non-exhaustive examples of topological relationships include:
the distance rᵢⱼ between keypoints i and j having respective coordinates (xᵢ, yᵢ) and (xⱼ, yⱼ), and
an angle [symbol] with its vertex at point j and formed between vectors \vec{ji} and \vec{jk}, where k is a point with coordinates (xₖ, yₖ).

Keypoint data represents information derived or calculated from the positions obtained by the input module 100.

When the processing module 200 applies processing to the obtained positions, the keypoint data comprises the positions transformed and/or enriched by such processing. Alternatively, in the absence of the processing module 200, the keypoint data are simply the positions obtained by module 100, without transformation or enrichment.

The structuring module 300 is configured to structure or organize the keypoint data coming from the processing module 200, into a structure usable by the determination module 400.

The structuring process may comprise generating a multidimensional tensor which groups the keypoint data.

The structuring process may comprise reordering, or reorganizing, keypoint data to reflect topological relationships through their order. In one example of natural ordering, keypoints are organized according to which finger they belong to, for example, (1, 2, 3, 4) for the thumb, (5, 6, 7, 8) for the index finger, and so on. This order reflects the adjacency of keypoints within a substructure (a finger). In another alternative example of ordering, points are grouped according to specific relationships, for example (4, 8, 12, 16, 20) groups the fingertips, (3, 7, 11, 5, 19) groups the proximal joints, etc.

If module 300 is unavailable, the natural order of positions or keypoint data coming from the preceding modules may be used directly. A concatenated vector of positions obtained by module 100 or of keypoint data coming from module 200 may be sufficient for implicitly conveying topological relationships, such as in the order (1, 2, 3, 4), (5, 6, 7, 8), etc.

The determination module 400 is configured to analyze the structured data produced by module 300 (or directly by the preceding module(s) if module 300 is absent) in order to determine a static configuration of the articulated structure.

Thus, module 400 may be configured to receive as input data:
a tensor which groups the structured keypoint data,
a vector of concatenated positions, or
a vector of concatenated keypoint data.

In one exemplary implementation, module 400 uses a convolutional neural network (CNN) to analyze the input data.

The CNN may be configured to extract local features from the input data (for example, relationships between adjacent keypoints), combine extracted local features to identify high-level patterns representing configurations (for example, “open hand,” “closed fist”), and classify the configurations into predefined categories, each category corresponding to a specific static configuration.

The CNN may be configured to determine a probability or score associated with each possible configuration category, for example in the form of a probability vector (“open hand”: 95%, “closed fist”: 5%).

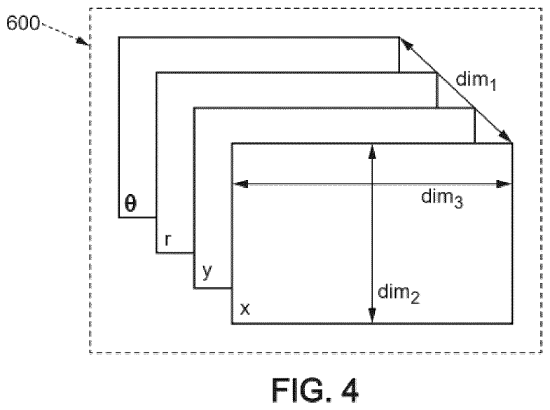

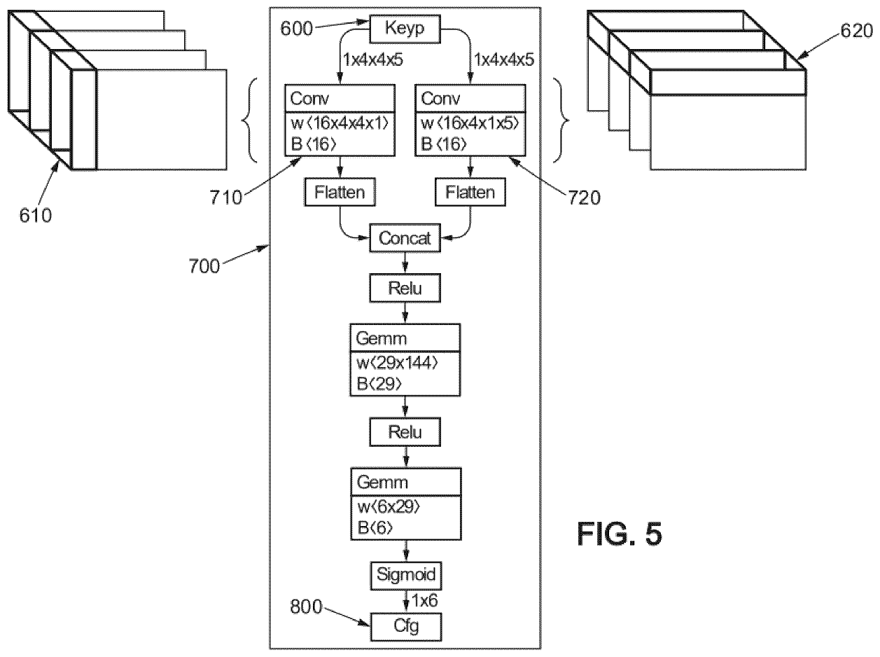

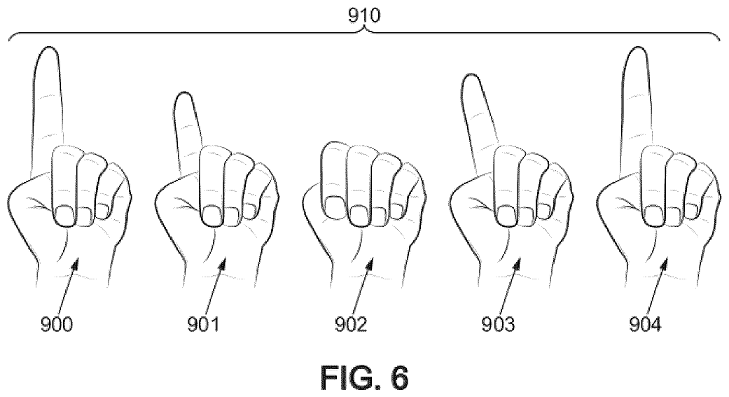

In one exemplary implementation, the articulated structure is a human hand, represented by 21 keypoints as shown in FIG. 2. The input data are structured as a tensor 600, as shown in FIG. 4, and module 400 analyzes the input data using a convolutional neural network 700, as shown in FIG. 5.

The first dimension dim₁ of the tensor 600 corresponds to the features associated with each keypoint. For example, in FIG. 4, each keypoint is described by four values (xᵢ−x₀, yᵢ−y₀, rᵢ, θᵢ), so dim₁=4. The second dimension dim₂ of the tensor 600 corresponds to the number of keypoints per articulated substructure. For example, in FIG. 4, each finger is described by four keypoints: for example the keypoints 1, 2, 3, and 4 represent the thumb, so dim₂=4. In this example, keypoint 0 is conventionally placed at the origin and does not belong to any articulated substructure. The third dimension dim₃ of the tensor 600 corresponds to the number of articulated substructures. For example, in FIG. 4, the hand has five fingers, so dim₃=5. The dimensions of the tensor are thus, in this example, 4×4×5.

The convolutional neural network 700 is configured to analyze the structured keypoint data and determine a static configuration of the hand by exploiting both low-level and high-level relationships between these keypoints. In one exemplary implementation, the convolutional neural network 700 comprises at least:
a convolutional layer 710 configured to extract low-level patterns based on data 610 representing keypoints of a same articulated substructure, and
a convolutional layer 720 configured to extract low-level patterns based on data 620 representing keypoints belonging to different articulated substructures but sharing topological relationships.

In order to isolate keypoint data 610 belonging to a same specific articulated substructure (a finger), based on the tensor 600, the index of dimension dim₃ is fixed. For example, the keypoint data for the thumb, indexed to index (dim₃)=1, are [*,*,1], with the notation * indicating that all values of dimensions dim₁ and dim₂ are included. This produces a 4×4 matrix where the four rows represent the keypoint features and the four columns represent the four keypoints describing the thumb (joints and tip).

The convolutional layer 710 applies sliding convolutional filters to this 4×4 matrix. Each filter analyzes the relationships between the keypoints of a single finger, detecting low-level patterns such as a linear or curved arrangement of these keypoints. The presence of distance values rᵢ or angles θᵢ in the data 610 facilitates the detection of these low-level patterns by the convolutional layer 710. If, for example, the keypoints of the thumb form a characteristic curve, this curve can be an indicator for recognizing a high-level gesture such as “open hand.” Based on the detected low-level patterns, the convolutional layer 710 generates a low-level feature map representing the patterns detected within each finger.

In order to isolate keypoint data 620, based on the tensor 600, belonging to different articulated substructures but sharing topological relationships, i.e., in this example the data from one of the following four groups of keypoints:
a group comprising keypoints 4, 8, 12, 16, 20 located at the fingertips,
a group comprising keypoints 3, 7, 11, 15, 19 located at the distal joints,
a group comprising keypoints 2, 6, 10, 14, 18 located at the intermediate joints, and
a group comprising keypoints 1, 5, 9, 13, 17 located at the proximal joints,
the index of dimension dim₂ is fixed. For example, the keypoint data for the fingertips, indexed to index (dim₂)=4, are [*,4,*]. This produces a 4×5 matrix where the four rows represent keypoint features and the five columns represent the five keypoints describing the fingertips.

The convolutional layer 720 applies sliding convolutional filters to this 4×5 matrix. Each filter analyzes the relationships between keypoints within a same group, detecting high-level patterns such as relative symmetry or spacing between fingertips. The presence of distance values rᵢ or angles θᵢ in the data 620 facilitates the detection of these high-level patterns by the convolutional layer 720. An arrangement of spread-apart fingertips might indicate an open hand, while fingertips arranged close together might indicate a closed fist. Based on the detected low-level patterns, the convolutional layer 720 generates a map of high-level features representing the detected relationships between the fingers.

In one possible exemplary architecture of a convolutional neural network 700, the outputs of the convolutional layers 710 (low-level features) and 720 (high-level features) are flattened into 1D vectors. These 1D vectors are then concatenated to form a single comprehensive vector. A ReLU activation function is applied to the comprehensive vector to introduce nonlinearity and enable the learning of complex relationships. Successive fully connected layers transform the comprehensive vector into an output vector. Finally, a sigmoid activation function is applied to the output to produce a probability vector 800, where each value represents the probability of a category or class in a set of n predefined classes, meaning in a discrete set of possible configurations.

One example of a probability vector might contain the following information:
Class 1 (“closed fist”): 5%,
Class 2 (“open hand”): 95%,
Other classes: 0%.

Describing the keypoints of a hand by using quadruplets (xᵢ−x₀, yᵢ−y₀, rᵢ, θᵢ) that represent both positional data and topological adjacency relationships, structuring the set of keypoints as a 4×4×5 tensor that highlights topological relationships between keypoints which may or may not belong to the same articulated substructure, and using a CNN configured to analyze these structured data, each contribute to improving the accuracy of the proposed method. Together, in certain experiments conducted by the inventors, these advances make it possible to increase the correct classification rate by more than 8% compared to existing methods for determining the static configuration of a hand. Thus, in at least some embodiments, the proposed technique combines the accuracy of image-based methods with the simplicity and efficiency of keypoint-based methods, offering a high-performance and cost-effective solution.

For example, module 500 may be configured to translate a probability vector determined by module 400, into a single configuration. This translation might involve selecting the class corresponding to the highest probability. Thus, if module 400 produces a probability vector indicating, for example, that the “open hand” configuration is associated with a 95% probability and the “closed fist” configuration with a 5% probability, module 500 interprets these results to determine that the hand is in the “open hand” position. Once this interpretation is complete, module 500 can convert this determined class into various formats suitable for specific use cases. For example, it may generate descriptive text such as “configuration detected: open hand,” which can be used in diagnostic systems or educational environments to provide detailed information about the detected configurations. Module 500 may also produce graphical representations, for example in the form of images or 3D models illustrating the detected configuration, which can be displayed in a user interface or used to simulate movement in an augmented or virtual reality environment.

In addition to descriptive text and graphical representations, module 500 may be configured to convert detected configurations into logic commands suitable for interactive systems. These commands may be used to activate specific actions in human-machine interfaces or in robotic systems. For example, if module 400 detects an “open hand” configuration, module 500 may interpret this configuration as a “select” command in a user interface, allowing the user to point to or click on an item displayed on the screen. Alternatively, if the detected configuration is a “closed fist,” module 500 may interpret this as a “grasp” command in a robotic system, for example in order to activate the grasping action of a robotic arm. These commands may also be associated with dynamic gestures when a sequence of static configurations is identified. For example, the dynamic gesture corresponding to a click, consisting of a succession of configurations: “index finger raised,” “index finger half-down,” “closed fist,” “index finger half-down,” “index finger raised,” can be interpreted by module 500 as a “virtual click” command in a user interface.

Module 500 may also transmit output data to external systems for various applications. For example, in an interactive context with a human-machine interface, descriptive text such as “configuration: open hand” or a “select” logic command may be sent to a navigation system in order to point to or select an element displayed on the screen. In robotic environments, a “grasp” command corresponding to a “closed fist” configuration may be transmitted to a robotic arm in order to enable it to manipulate an object. In an augmented reality environment, a graphical representation of the detected configuration may be displayed to the user in order to visualize the status or movement of the hand. Furthermore, module 500 may integrate these results into educational or training systems, generating detailed reports on the detected gestures or providing a visual representation of configurations in order to aid in learning joint movements.

In addition to these interactive actions and visual representations, module 500 may be configured to produce structured data streams for analysis systems or monitoring systems. For example, it may transmit the detected static or dynamic configurations as symbols or codes. Within a complex human-machine interface, these symbols can be combined into sequences to represent more complex dynamic gestures. For example, module 500 may associate the symbol “I” with a “raised index finger” configuration, “P” with a “closed fist” configuration, and generate a sequence such as “IiPiI” to indicate a click. These sequences can then be used by external systems to execute complex commands or to display as descriptive text, for example “command detected: click.” This flexibility makes it possible to meet the varied needs of interactive systems, whether for applications in robotics, home automation, virtual or augmented reality, or even medical systems requiring contactless interaction.

Module 500 may therefore be viewed as an interface which allows linking the results from module 400 to concrete applications, by translating these results into formats adapted to the requirements of the users and/or connected systems.

FIG. 6 illustrates one example of a dynamic configuration 910 of a hand, formed by a succession of different elementary static configurations numbered 900, 901, 902, 903, and 904. These static configurations represent intermediate hand positions, captured at different points in time.

In this example, the dynamic configuration 910 corresponds to a complex gesture simulating a virtual click, consisting of the following actions: lowering the index finger, forming a closed fist, and then raising the index finger. Each step of this gesture can be represented by an elementary static configuration. The first static configuration 900 corresponds to an initial position where the index finger is raised, indicating a waiting or ready posture. The next configuration, 901, captures an intermediate stage where the index finger is half-lowered, representing the beginning of the clicking movement. Configuration 902 corresponds to a closed fist, representing the apex of the dynamic motion, where the index finger is fully lowered. Configuration 903 returns to an intermediate position similar to 901, but in a release phase, and, finally, configuration 904 corresponds to the return to the initial position with the index finger raised once again.

This breakdown of a dynamic gesture into elementary static configurations allows a modular approach to recognizing dynamic gestures. The determination module 400 may be configured to detect and identify the static configurations 900, 901, 902, 903, and 904 independently. Then, the output module 500 may be configured to associate these configurations with distinct symbols (for example, “I” for raised index finger, “i” for half-lowered index finger, and “P” for closed fist), and then to generate a sequence of symbols corresponding to the complete dynamic motion of the gesture. The symbol sequence can be interpreted to detect movement or the absence of movement by applying a predefined criterion. For example, the absence of movement can be detected if the same symbol is repeated at least a certain number of consecutive times in the sequence (for example, “PPPPPPPP” for a held closed fist). Conversely, the presence of several different symbols within a sequence of a given size can indicate movement. The size of a sequence is defined as the total number of symbols it contains. In practice, a sequence may be very long, which can make its complete analysis more complex. To simplify this analysis, a sequence may be divided into smaller portions, each portion corresponding either to an identified or unidentified movement, or to the absence of movement. This division allows dynamic gestures to be treated as a series of elementary analytical units. For example, a sequence “IIPPPiiiPPP” can be interpreted as corresponding to a dynamic gesture comprising several steps: a raised index finger (“II”), a closed first (“PPP”), a half-lowered index finger (“iii”), and then another closed first (“PPP”). Each portion can be analyzed to determine its contribution to a general gesture.

For example, for the dynamic configuration 910, the symbols associated with the elementary static configurations are as follows:
configuration 900 is associated with the symbol “I” (raised index finger),
configuration 901 is associated with the symbol “i” (half-lowered index finger),
configuration 902 is associated with the symbol “P” (closed fist),
configuration 903 is associated with the symbol “i” (half-lowered index finger), and
configuration 904 is associated with the symbol “I” (raised index finger).

The resulting sequence, “IiPiI”, is then analyzed by the output module 500, which recognizes it as a virtual click.

The use of such a sequence of symbols facilitates managing the variations in the execution of dynamic gestures. For example, if the gesture is performed more slowly or more quickly, resulting in repetitions or deviations in the detected configurations (e.g., “IIIiPPiiII” instead of “IiPiI”), or in the event of an isolated error by module 400 in recognizing a static configuration, the sequence can still be recognized due to the use of regular expressions. In other words, the use of such a sequence of symbols offers increased robustness in recognizing a dynamic configuration of an articulated structure.

The regular expressions allow describing flexible patterns for searching for sequences in a stream of symbols. For example, in the case of the gesture corresponding to a click (ideal sequence: “IiPiI”), a regular expression may be designed to identify sequences that comply with the order of the steps in the gesture (index finger raised, then index finger halfway down, then closed fist, then back up), while tolerating unintentional repetitions, such as several consecutive “I”s or “i”s (e.g., “IIiiPPiiII”), and ignoring insignificant or poorly detected intermediate configurations (e.g., an underscore “_” inserted between two configurations).

For example, for the “click” gesture, a possible regular expression might be “|+i*P+i*|+”, where
I+ denotes one or more consecutive occurrences of “I” (index finger raised).
i* denotes zero, one, or more occurrences of “i” (index finger halfway down), and
P+ denotes one or more occurrences of “P” (closed fist).

Thus, module 500 may be configured to search for a match between an obtained sequence of symbols (e.g., “IIIiPPiiII”) and the regular expression “I+i*P+i*I+”, and, upon detecting such a match, generates a command corresponding to a click.

The search for a match may be based on a similarity measure between the detected sequence and one or more reference sequences, such as pre-recorded sequences (for example a regular expression). Various algorithms for calculating the distance or similarity may be used, depending on the embodiment. For example, these may be algorithms for calculating the distance or similarity in multi-dimensional spaces such as those of symbol sequences, in particular Levenshtein distance, dynamic time warping (DTW) algorithms, etc.

The ability to recognize a dynamic structure by using a sequence of symbols associated with specific static configurations is not limited to the case where the dynamic configuration corresponds to a click, but can be applied to many dynamic configurations that may or may not be interpreted as commands. For example, a “zoom in” command may be triggered upon detecting a sequence of static configurations where the fingers gradually move apart, while a “zoom out” command may be triggered upon detecting a sequence of static configurations where the fingers are moving closer together. Similarly, commands such as “drag” or “rotate” may be triggered upon detecting sequences of elementary static configurations reflecting intermediate steps of a corresponding movement. Other regular expressions may thus be defined for various supported dynamic configurations.

Alternatively, it is possible to directly analyze successive static configurations in order to identify a dynamic configuration without going through an explicit step of symbol conversion.

In a first example, the elementary static configurations detected by module 400 may be directly processed as temporal feature vectors. Each static configuration is represented by a set of numerical features (for example keypoint coordinates, relative distances, angles, or other topological relationships). These feature vectors are then grouped into a temporal structure, such as a sequence or matrix, which is analyzed by a temporal classifier such as a recurrent neural network (RNN) or a variant such as an LSTM. These models are configured to detect patterns in the variation of temporal features, thus enabling a dynamic configuration such as a click, zoom, or swipe to be recognized without prior conversion of the static configurations into symbols.

In a second example, a dynamic configuration may be recognized using a statistical approach based on probabilistic models. Here, each elementary static configuration is associated with a conditional probability that depends on the preceding and following static configurations in the temporal sequence. A model such as a hidden Markov network (HMM) can be trained to represent the probable transitions between static configurations within a given dynamic gesture. Once the model is trained, the dynamic configuration can be determined by identifying the most probable sequence of transitions corresponding to the observed static configurations. For example, for a click, the HMM model can capture the high probability of a transition from “index finger raised” to “index finger half lowered”, then to “closed fist”, and finally back to “index finger raised”.

In a third example, the dynamic configuration may be recognized using a 3D convolutional neural network (3D CNN), designed to directly process temporal sequences of static configurations. In this approach, the keypoint data of each static configuration are structured as three-dimensional tensors where an additional dimension represents the evolution over time. The 3D CNN extracts spatiotemporal features by simultaneously analyzing the relationships between keypoints at a given time and their variation over time. This approach enables a robust recognition of dynamic gestures by taking into account both low-level (within a static configuration) and high-level (between successive configurations) features.

### INDUSTRIAL APPLICATION

The technical solutions proposed in this disclosure can have applications in many fields where they contribute to improving human-machine interactions, the efficiency of automated systems, and/or the accuracy in recognizing articulated configurations. These solutions can be integrated into gesture-based control systems, augmented or virtual reality environments, and/or advanced robotic systems.

Furthermore, this disclosure is not limited to the exemplary embodiments described above, which are provided for illustrative purposes only. It encompasses all variations and modifications conceivable to a person skilled in the art within the scope of the claims and the protection sought. These variations include, but are not limited to, adaptations to different types of articulated structures, the use of combinations of several neural networks, and/or various types of structuring and processing of keypoint data.

In particular, although the examples described focus on a two-dimensional representation of keypoint positions, a three-dimensional representation is also possible. In such case, the position data of a keypoint may be represented by three Cartesian coordinates and one, two, or three additional coordinates in another coordinate system (for example, a distance and zero, one, or two angles).

What is claimed is:

1. A method for determining a configuration of an articulated structure,
the method being implemented by a computer, and
the determination of the configuration of the articulated structure taking into account:
positions of keypoints of the articulated structure, and
at least one topological relationship between keypoints,
wherein the determination of the configuration is repeated over time, the method comprising:
determining a movement of the articulated structure, based on the determined configurations.

2. The method according to claim 1, wherein the positions of the keypoints are expressed in a first coordinate system and the at least one topological relationship is expressed in a second coordinate system.

3. The method according to claim 2, wherein the first coordinate system is a Cartesian coordinate system and the second coordinate system is a polar, cylindrical, or spherical coordinate system.

4. The method according to claim 1, wherein the articulated structure comprises a hand and a wrist.

5. The method according to claim 1, wherein the articulated structure is divided into a plurality of articulated substructures, each substructure comprising at least one joint and/or at least one end.

6. The method according to claim 1, wherein a topological relationship comprises a distance and/or an angle.

7. The method according to claim 1, wherein a topological relationship is at least one element of a list comprising:
a proximity relationship between keypoints,
a relationship between keypoints belonging to a same articulated substructure, or
a relationship between keypoints belonging to different articulated substructures.

8. The method according to claim 1, wherein the determined configuration of the articulated structure is chosen from a discrete set of possible configurations.

9. The method according to claim 1, wherein the determination of the dynamic movement of the articulated structure comprises:
constructing a sequence of symbols, a symbol representing a determined configuration; and
detecting a pattern in the sequence of symbols.

10. The method according to claim 1, wherein the configuration of the articulated structure is determined using a convolutional neural network.

11. The method according to claim 10, wherein the convolutional neural network is applied to data structured in a form that allows deducing at least one topological relationship.

12. The method according to claim 1, comprising a determination of a user command based on a similarity between the determined configuration and a configuration associated with the command.

13. A module for determining a configuration of an articulated structure,
the determination taking into account:
positions of keypoints of the articulated structure, and
at least one topological relationship between keypoints,
where the determination of the configuration is repeated over time,
the module being configured to:
determine a movement of the articulated structure based on the determined configurations.

14. The module according to claim 13, wherein the positions of the keypoints are expressed in a first coordinate system and the at least one topological relationship is expressed in a second coordinate system.

15. The module according to claim 13, wherein a topological relationship comprises a distance and/or an angle.

16. The module according to claim 13, wherein the configuration of the articulated structure is determined using a convolutional neural network.

17. The module according to claim 16, wherein the convolutional neural network is applied to data structured in a form that allows deducing at least one topological relationship.

18. A non-transitory, computer-readable storage medium on which are stored program code instructions of a computer program, when executed by a processor, lead the processor to execute a method for determining a configuration of an articulated structure,
the determination of the configuration of the articulated structure taking into account:
positions of keypoints of the articulated structure, and
at least one topological relationship between keypoints,
the determination of the configuration being repeated over time, and the method comprising:
determining a movement of the articulated structure, based on the determined configurations.

19. The storage medium according to claim 18, wherein the positions of the keypoints are expressed in a first coordinate system and the at least one topological relationship is expressed in a second coordinate system.

20. The storage medium according to claim 18, where a topological relationship comprises a distance and/or an angle.
